(19) United States
(12) Patent Application Publication
(10) Pub. No.: US 2008/0244423 A1
(43) Pub. Date: Oct. 2, 2008

(54) MELTING GROUPS

(75) Inventors: Leif Jensen-Pistorius, Oestringen (DE); Peer Hilgers, St. Leon-Rot (DE)

Correspondence Address: SCHWEGMAN, LUNDBERG & WOESSNER/SAP, P.O. BOX 2938, MINNEAPOLIS, MN, 55402, US

(73) Assignee: SAP AG

(21) Appl. No.: 11/692,574

(22) Filed: Mar. 28, 2007

(51) Int. Cl. G06F 3/048

(52) U.S. Cl. 715/763

(57) ABSTRACT

In one embodiment, a method is illustrated as including assembling one or more User Interface (UI) elements as a single UI element in the form of a melting group and placing the single UI element into a melting group container, associating the container with a layout element, and generating metadata illustrating data relating to the container and the layout element. Further, this method may include separating the one or more UI elements using an item separation attribute and sizing the one or more UI elements using a sizing attribute, wherein the one or more UI elements include at least one of a container, table, graphic, item list box, explanatory text, textbox, button group, radio button group, or checkbox group. Additionally, the metadata may be formatted using an eXtensible Markup Language (XML).

### CROSS REFERENCE TO RELATED APPLICATIONS

This is a non-provisional patent application that is related to U.S. patent application titled: “COLUMN LAYOUT” (application Ser. No. 11/692,334) that is incorporated by reference in its entirety.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document: Copyright© 2007, SAP AG. All Rights Reserved.

### TECHNICAL FIELD

The present application relates generally to the technical field of algorithms and programming and, in one specific example, to the optimization of a Graphical User Interface (GUI).

### BACKGROUND

GUIs come in many forms and can be used to facilitate user interaction with, for example, a distributed computing environment (e.g., a web based application), or an application residing wholly on a single computer system (e.g., a stand-alone application). Common to these GUIs is the association of certain functionality with specific regions of each of the GUIs. This functionality may be illustrated to the user via, for example, various collections of screen objects or widgets.

### BRIEF DESCRIPTION OF THE DRAWINGS

Some embodiments are illustrated by way of example and not limitation in the figures of the accompanying drawings in which:

FIG. 1 is a diagram of a system for inserting a melting group container into a layout, according to an example embodiment.

FIG. 2 is a diagram of a layout containing a number of different types of layout elements, according to an example embodiment.

FIG. 3 is a diagram of an item separation table illustrating some of the separation values associated with User Interface (UI) elements contained in a melting group container, according to an example embodiment.

FIG. 4 is a diagram of a sizing table illustrating the various sizing methods may be used to size UI elements contained within a melting group container, according to an example embodiment.

FIG. 5 is a diagram of a melting group container illustrating various UI elements whose logic is compliant with the Core Component Technical Specification (CCTS) standard, according to an example embodiment.

FIG. 6 is a diagram of a system illustrating the insertion of a melting group container into a display area and the subsequent generation of business logic and display logic supporting and implementing this melting group container, according to an example embodiment.

FIG. 7 is a block diagram of a device for associating a melting group container and layout element, according to an example embodiment.

FIG. 8 is a block diagram of an application server that receives metadata used to generate, among other things, display and business logic, according to an example embodiment.

FIG. 9 is a flowchart illustrating a method used to generate a melting group container and associate this melting group container with a layout, according to an example embodiment.

FIG. 10 is a flowchart illustrating an execution of an operation to associate a container such as a melting group container with a layout element, according to an example embodiment.

FIG. 11 is a block diagram of a device used to render an application GUI, according to an example embodiment.

FIG. 12 is a flowchart illustrating a method for rendering an application GUI, according to an example embodiment.

FIG. 13 is a flowchart illustrating a method used to implement an operation to parse input that is received by a UI element that is part of a melting group, according to an example embodiment.

FIG. 14 is an example Relational Database Schema (RDS) used to manage a melting group container, according to an example embodiment.

FIG. 15 shows a diagrammatic representation of a machine in the example form of a computer system, according to an example embodiment.

### DETAILED DESCRIPTION

In the following description, for purposes of explanation, numerous specific details are set forth in order to provide a thorough understanding of an embodiment of the present invention. However, it will be evident, to one skilled in the art that the present invention may be practiced without these specific details.

The leading digit(s) of reference numbers appearing in the Figures generally corresponds to the Figure number in which that component is first introduced, such that the same reference number is used throughout to refer to an identical component which appears in multiple figures. Signals and connections may be referred to by the same reference number or label, and the actual meaning will be clear from its use in the context of the description.

In one embodiment, a method is illustrated as including assembling and treating one or more UI elements as a single UI element (e.g., treating as a melting group), and placing the single UI element into a container (e.g., the container being a melting group container) that resides as part of a layout. Further, the container may then be associated with a layout element, and metadata may be generated illustrating the relationship between the melting group container and the melting group. Moreover, this method may include separating the one or more UI elements using an item separation attribute, and sizing the one or more UI elements within the container using a sizing attribute, wherein the one or more UI elements include at least one of a container, table, graphic, item list box, explanatory text, textbox, button group, radio button group, or checkbox group. Additionally, the metadata may be formatted using an eXtensible Markup Language (XML). Moreover, the separation attribute may include a pixel value, a character value, or a relative percent value, and the sizing attribute may include a pixel value, a character value, or a relative percent value.

Other features may be apparent from the accompanying drawings and from the detailed description that follows.

In some embodiments, a GUI is implemented using a declarative programming regime where, for example, a plurality of UI elements residing in a container (e.g., a melting group container) is associated with certain layout elements such that the plurality of UI elements are treated as one UI element (e.g., they are melted into one element). Some well known development environments that follow a declarative programming regime include VISUAL COMPOSER™ by SAP AG, or some other NETWEAVER™-based application. The containers used in melting group containers may be any one of a number of layout elements including columns, nested columns, table view cells, tab strip containers, or some other suitable layout element. These various layout elements are illustrated more fully in U.S. patent application Ser. No. 11/692,334 titled “Column Layout”, which is incorporated herein in its entirety.

In determining the various separation and sizing issues related to the UI elements in a melting group container, these separation and sizing issues need not be considered for each of the UI elements residing in a layout. Rather, the separation and sizing issues are considered as distinct from these issues as they exist for other UI elements not contained in the melting group container. Put another way, the melting group container, and the UI elements contained therein, are distinct from the other UI elements contained in a layout.

In some cases, the input received by the group of UI elements associated with this container is parsed and formatted according to one or more Document Type Definitions (DTD), and/or XML Schema Definitions (XSD) (collectively schemas), where the schemas serve as a type of grammar. These schemes may include an Electronic Business eXtensible Markup Language (EBXML) standard reflecting the Core Component Technical Specification (CCTS) In using schemas such as EBXML, a melting group container can provide functionality that supplements, or is distinct from, the functionality provided by other UI elements associated with a layout element. For example, in some embodiments, UI elements and layout elements may be layered (see e.g., a tab strip container) such that layout elements nested within, for example, a tab strip container may contain a melting group container whose UI elements are governed by one type of schema; whereas another tabbed field is controlled by the tab strip, and its associated column and melting group container residing therein is governed by another schema. Multiple layers of layout elements may be implemented controlling UI elements, with each governed by separate schema.

Example embodiments may include the separation and spacing of the various UI elements grouped into the container using one or more separation values. These separation values may be defined in terms of metrics (e.g., units) including pixels, characters, or various relative percentage values. For example, the separation between two UI elements may be defined as a 3 pixel (PX) separation, a 20 PX separation, a 35 PX separation, or some other suitable separation value. In some cases, an editing window is provided as part of a development environment implementing a declarative programming regime, such that a user (e.g., a software developer) may drag and drop multiple UI elements into a container (e.g., forming a melting group), and the separation values may be automatically associated with the UI elements. In some embodiments, a user will be able to select the separation values, rather than having them automatically determined.

Some example embodiments may include the sizing of various UI elements grouped into the container using one or more sizing values. These sizing values may be defined in terms of units including pixels, characters, or various relative percentage values. For example, a user (e.g., a software developer) may determine a particular UI element contained in a melting group container should take up 33% of the available area within this melting group container (e.g., should be assigned a relative percentage value). In cases where this percentage value cannot be met (e.g., the container is reduced or expanded in size during run time), the UI element within the melting group container may need to be repositioned. Repositioning may take place within the melting group container itself, or, in some cases the entire melting group container may be repositioned. This concept of the repositioning is illustrated in U.S. patent application Ser. No. 11/692,334 titled “Column Layout”, which is incorporated herein in it entirety.

### Example Association of Melting Group Container and Layout Element

In some cases a melting group container allows a user to put several UI elements (e.g., two or more) into one cell of a layout element (e.g., a column). This melting group container may only contain UI elements of a similar height (e.g., one character), width, and of a similar type (e.g., input fields, textviews, checkboxes, or other suitable UI element). In some cases, UI elements of a diverse type may be used in the melting group container. Further, in some cases, if UI elements of differing heights and widths are used in a melting group they may push the height or width of the lines defining the height or width of the melting group container, such that the melting group container may infringe the space occupied by other UI elements or layout element. In cases where the melting group container infringes space occupied by other UI elements, or layout elements, the melting group container may need to be repositioned to a position in the layout where available space does exist. If several melting groups, and associated melting group containers, are used within a layout, their content may not be aligned with the content of the other melting groups. The melting group itself may use 100% of the available space of its parent melting group container (e.g. column layout cell, tableview cell, or other suitable layout element).

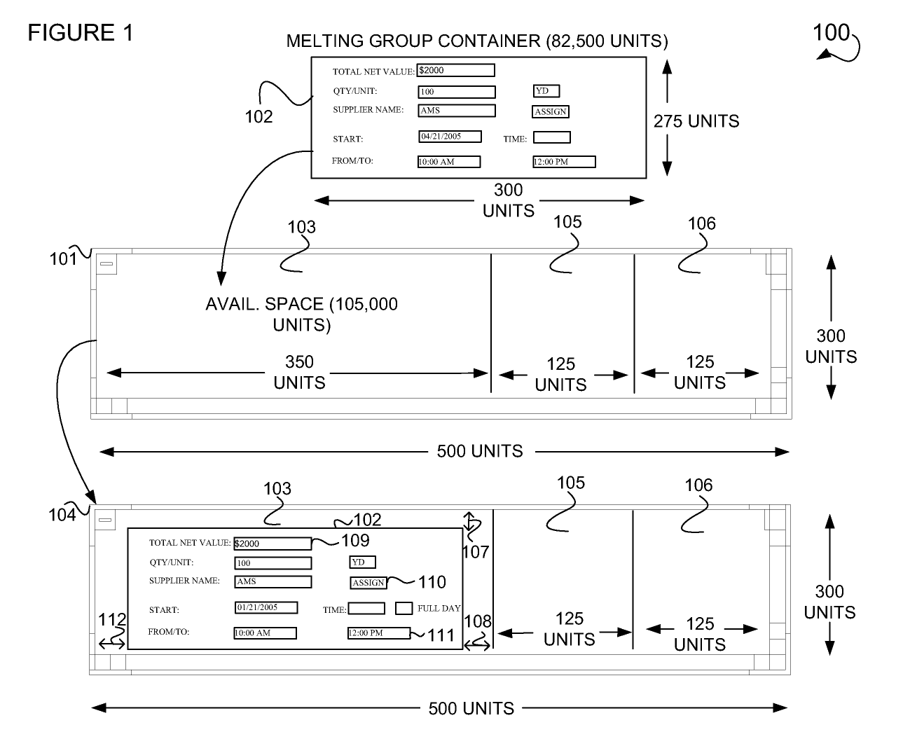

FIG. 1 is a diagram of an example system 100 for inserting a melting group container into a layout. Illustrated is a layout 101 into which is inserted a melting group container 102. This melting group container 102 has an area of 82,500 units. Layout 101 is divided into three sections denoted by 103, 105, and 106, each of which is a column layout element. Column layout element 103 has an available space of 105,000 units, which reflect the area contained within the column layout element 103. This area is large enough to accommodate the melting group container 102. Additionally illustrated is a layout 104 that shows the insertion of the melting group container 102 into column layout element 103. The melting group container 102 contains a number of UI elements including, for example, textboxes 109, 110 and 111. Also shown are various orientation arrows 107, 108 and 112. These orientation arrows denote the dimensions of the column layout element 103, and the distance or orientation of the melting group container 102 relative to it. For example, orientation arrow 107 may denote the melting group container being 4 characters from the top of the column layout element 103, and orientation arrows 112 and 108 may denote a spacing of 7 characters from the side of the column layout element 103.

In some cases, the orientation of the melting group container 102 may be determined based upon the previously illustrated orientation arrows (e.g., 107, 108 and 112), or may be based upon some type of relative percentage value. With regard to the relative percentage value, and orientation determined based upon this value, in some cases, a melting group container 102 may be understood in terms of the percent of available space that it occupies within, for example, a layout element column (e.g., 103, 105, and 106). In such a case, the orientation arrows (e.g., 107, 108, and 112) may serve only to position the melting group container 102.

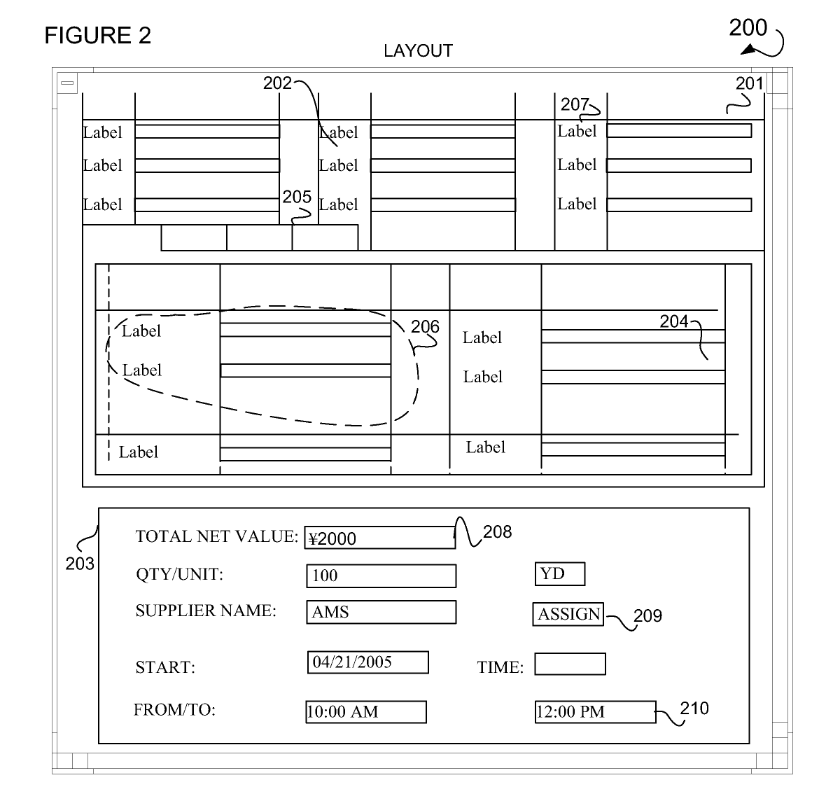

FIG. 2 is a diagram of an example layout 200 containing a number of different types of layout elements. Illustrated is a column 201 containing a plurality of UI elements 207 that are inserted into the layout. Further, a form pane 202 is illustrated as also being inserted into the layout. Additionally, a tab strip container 205 is shown that contains various form pane controls 206 and even a nested column tab strip 204. Also shown is a melting group container 203 that is inserted into the layout 200, and that contains a number of UI elements such as textboxes 208, 209 and 210. With regard to the textbox 208, a value of y2000 has been entered. As will be more fully illustrated below, in some cases, the UI elements that make up a melting group container such as 203 may be supported by certain types of display and business logic that enable these UI elements to receive and process input according to, for example, CCTS or some other specification known in the art. This CCTS, and its relationship to melting group containers such as 102 and 203, will be more fully illustrated below.

### Example Setting of Separation, Sizing, and Input Types for a Melting Group Container

Example embodiments may include a melting group as a UI control that allows for combining several UI elements in its content area (e.g., melting group items) that act towards its parent container (e.g., layout element) as a single element. Each melting group item (e.g., a UI element) may have its own width as a fixed value or percentage value. Further, in some embodiments, melting groups do not wrap. That is, when the available area with which they are associated cannot accommodate them, they cannot be wrapped around to the available space on the next line, but instead may be repositioned.

In some embodiments, the distance between the individual UI elements is defined through an item separation attribute. In some cases, the default value of this item separation attribute is 3 PX. In order to allow different spacing each item in the melting group can define a different separation using, for example, values such as: default, small, medium, large, small with line, medium with line, and large with line. In lieu of or in addition to pixel-based item separation attribute values, characters may also be used to separate UI elements.

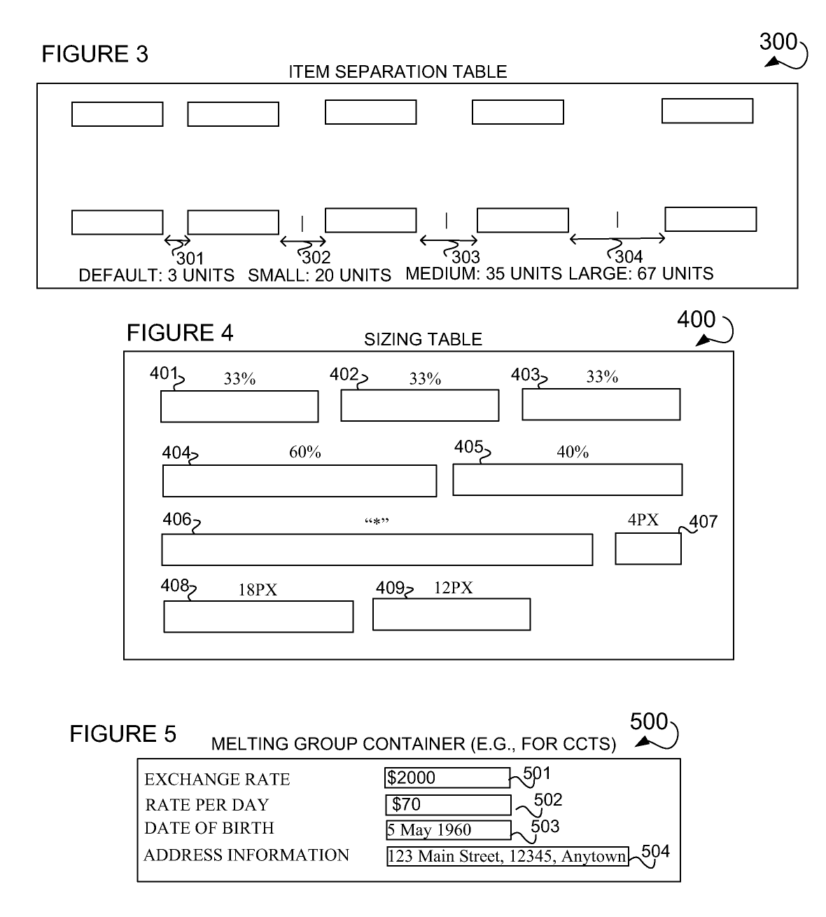

FIG. 3 is a diagram of an example item separation table 300 illustrating some of the separation values associated with UI elements contained in, for example, a melting group container such as 102 or 203. Illustrated is a default separation or spacing value 301 of 3 units. Next, a small separation or spacing value 302 of 20 units is shown. Additionally, a medium separation or spacing value 303 of 35 units is shown. Further, a large separation or spacing value 304 of 67 units is shown. In lieu of, or in addition to, using units as a basis for determining the spacing between UI elements contained in, for example, a melting group container, character values and/or character size relative to percentage value or orientation may be used. In some embodiments, the separation or spacing of certain UI elements may be based upon empirical testing and/or modeling such that in some cases a What You See Is What You Get (WYSIWYG) approach may be implemented in lieu of, or in addition to, some type of relative percentage value and/or orientation approach to spacing UI elements.

FIG. 4 is a diagram of an example sizing table 400 illustrating the various sizing methods that may be used to size UI elements contained within a melting group container such as 102 or 203. A number of textboxes (e.g., 401-405) are shown that have a certain relative percentage value associated with them. A 33% value is associated with each one of textboxes 401, 402, and 403, whereas percentage values of 60% and 40% are associated with textboxes 404 and 405, respectively. In some cases, the size of a textbox may be based upon the amount of space that it takes up relative to the amount of available space. For example, if a melting group container has an area of 82,500 units and a textbox is only allowed to take up 33% of this area, then the area of the textbox can be no larger than 27,225 units.

In addition to or in lieu of using a relative percentage value for determining the size of a UI element contained in a melting group container such as 102 or 203, character values and/or pixel values may be used. For example, illustrated is a textbox 406 that is sized based upon a particular character value. Also shown are textboxes 407, 408 and 409 that are sized based upon certain PX values reflecting height and width. In certain instances, a UI element may be sized based upon some type of predetermined number of characters. For example, textbox 406 may be determined to be 30 characters in width, and one character in height. Similarly, PX values alone may be used such that a textbox may be determined to be no larger than 100 PX in width and 6 PX in height (see e.g., textboxes 407-409). In some cases, the sizing of a UI element contained within, for example, a melting group container such as 102 or 203 may be determined through empirical testing and/or modeling, such that in some instances, a WYSIWYG approach may be implemented, whereas in other embodiments, some other approach may be implemented.

FIG. 5 is a diagram of an example melting group container 500 illustrating various UI elements which are compliant with the CCTS standard. Textbox 501 is labeled “Exchange Rate”, and contains an input of “$2,000” United States Dollars (USD). Textbox 502 is labeled “Rate per Day”, and contains an input of “$70” USD. Textbox 503 is labeled “Date of Birth”, and contains an input of “5May 1960”. Further, textbox 504 is labeled “Address Information”, and contains an input of “123 Main Street, 12345 Any Town”. In some embodiments, CCTS is used to standardize data inputs for, for example, a melting group container such as 102 or 203. This CCTS outlines, among other things, various data types which are then standardized by the specification. These data types include, for example, an address data type, a currency identifier data type, a date of birth data type, and a base charge data type. In some cases, the data entered into these various UI elements is entered according to some type of format outlined in a technical specification such as CCTS. The UI elements may automatically format the data, rather than forcing a using to enter the data in particular format. Once formatted, this data may be encoded utilizing, for example, the EBXML standard.

### Example System for Associating a Melting Group Container and a Layout Element

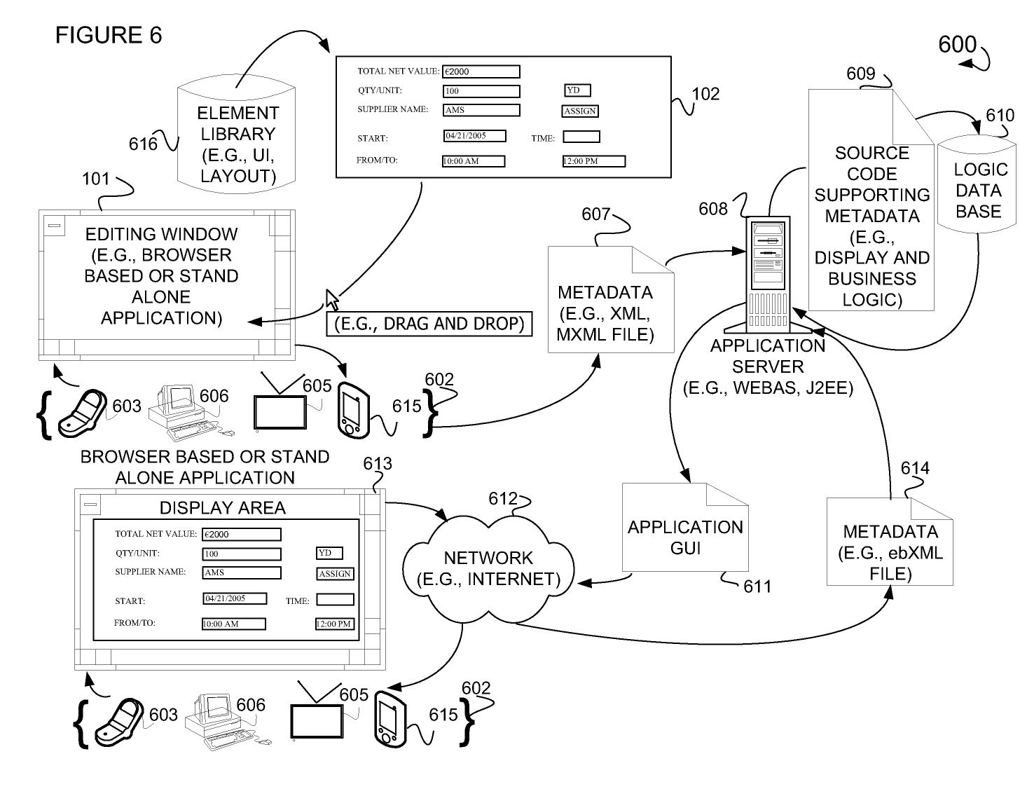

FIG. 6 is a diagram of an example system 600 illustrating the insertion of a melting group container into a layout, and the subsequent generation of business logic and display logic supporting and implementing this melting group container. A layout 101 is shown, into which is inserted a melting group container 102. The UI elements that make up this melting group container may, in some cases, be retrieved from an element library 616 and edited within this layout 101. In some cases, the layout 101 will be displayed in an editing window that resides upon one or more devices 602, including a cell phone 603, a computer system 606, a television 605, and/or a Personal Digital Assistant (PDA) 615. In some cases, an input device such as a mouse may be used to implement a drag and drop method, wherein the melting group container 102 is selected from the element library 614, and is dragged and then subsequently dropped into some available space contained within the layout 101.

Once the melting group container 102 is placed into the layout 101, it is then associated with a certain available space within this layout 101 and is oriented in a certain manner to this available space. In some cases, once this association takes place, metadata 607 is generated and transmitted by one or more of the devices 602. As previously illustrated, metadata 607 may be, for example, an XML file, a Media eXtensible Markup Language (MXML) file, or some other suitable file type. In some cases, once this metadata 607 is generated, it is transmitted to an application server 608, for example, a WEBAS™, or J2EE™ application server.

Once the metadata 607 is received at application server 608, supporting source code is generated for the metadata 607, as shown in 609. This supporting source code may be, for example, business logic, display logic, or some other suitable type of source code that facilitates the display of the melting group container 102 and its associated layout 101. The metadata 607 and source code 609 may then be stored in a logic database 610 for retrieval at a later point. In some cases, a user may wish to utilize the melting group container 102 as a GUI for an application. In such a case, a user utilizing one of the devices 602 may access an application via an application GUI 611 across a network 612. This access may be facilitated via, for example, a browser-based or stand-alone application 613. This browser-based or stand-alone application 613 may reside on any one of the devices 602, and may be accessed across a network 612, as previously illustrated, such that the browser-based or stand-alone application 613 may initiate a session with the application server 608, which will in turn retrieve the display and business logic associated with the particular application interface, and provide this application interface (as an application GUI 611) to the user utilizing one of the devices 602.

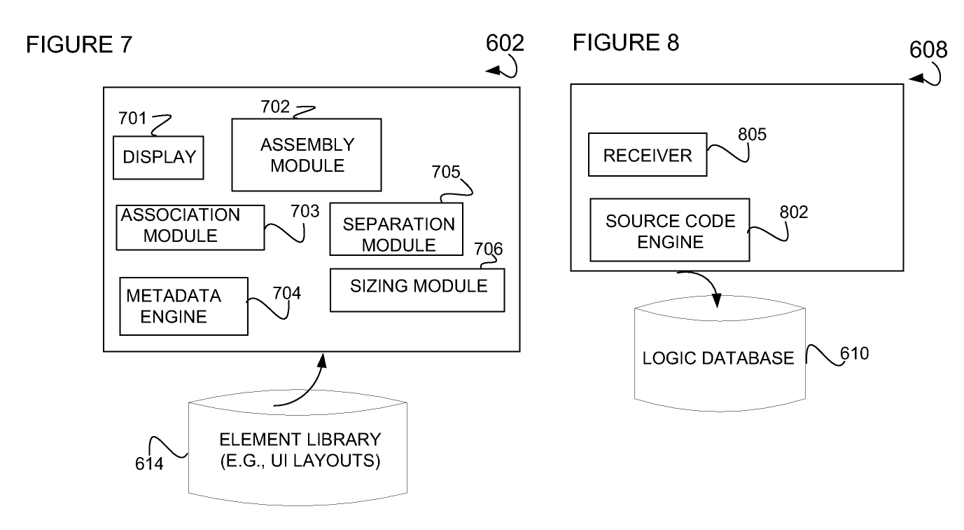

FIG. 7 is a block diagram of an example device 602. The various blocks that make up this block diagram, may be implemented in, for example, hardware, firmware, or software. A display module 701 is illustrated that is operably coupled to the device 602. Further, an association module 703 is disclosed that assists in facilitating the association of a melting group container with a particular layout and/or in some cases, layout element. A metadata engine 704 is shown that facilitates the generation of metadata (e.g., metadata 607). Further, a separation module 705 is shown that assists in the separation of the various UI elements contained within the melting group container (e.g., 102, 203). Additionally, a sizing module 706 is illustrated that facilitates the sizing of the various UI elements (e.g., 110, 111). As previously illustrated in respect to FIG. 4, this sizing can be based upon such approaches as a relative percentage value approach, or, for example, a WYSIWYG approach. Operably coupled to this device 602 is an element library 614. This element library 614 may natively reside on the device 602, or may be operably coupled to the device 602 yet be managed by and reside on some other device. In some cases, this element library 614 may be a library and/or a database organized according to certain principles of Online Analytical Processing (OLAP), or may be organized according to certain principles of Relational Databases (RDB).

Some embodiments may include a device 602 containing an assembly module 702 to assemble one or more UI elements as a single UI element and to place the single UI element into a container, an association module 703 to associate the container with a layout element, and a metadata engine 704 to generate metadata relating to the container and the layout element. Further, device 602 may additionally include a separation module 705 to separate the one or more UI elements using an item separation attribute, and a sizing module to size the one or more UI elements within the container using a sizing attribute, wherein the one or more UI elements include containers, tables, graphics, item list boxes, explanatory text, textboxes, button groups, radio button groups, and checkbox groups. Additionally, a separation attribute may also be illustrated as including a pixel value, a character value, and a relative percent value, each of which may be used as a metric to determine the proper spacing of UI elements contained within the melting group (see e.g., 301-304). Moreover, example embodiments may include various sizing attributes such as a pixel value, a character value, and a relative percent value (see e.g., 401-409).

FIG. 8 is a block diagram of an example application server 608. The various blocks that make up this block diagram, may be implemented in, for example, hardware, firmware, or software. A receiver 805 is illustrated that receives metadata such as metadata 607. The receiver 805 may be, for example, some type of network adaptor card or other device that facilitates, or provides for, an interface between the application server 608 and, for example, one or more of the devices 602. Additionally, a source code engine 802 may reside on the application server 608. As previously illustrated, the source code engine 802 may be used to generate source code in the form of display logic and/or business logic. As will be more fully illustrated below, this source code may include source code written in Java or in an Advanced Business Application Programming (ABAP) language, or some other suitable language. Operably coupled to the application server 608 is a logic database 610. The logic database 610 may reside natively as part of the application server 608, or may be managed by and run by a separate device. The logic database 610 may be formatted according to certain principles of OLAP, as a relational or object relational database, or some other suitable database format. Additionally, in some embodiments, the various modules 701-706 (shown in FIG. 7) may reside on the application server 608. This is especially true in cases where the application server 608 is used to develop applications using a declarative programming regime.

### Example Method for Associating a Melting Group Container and a Layout Element

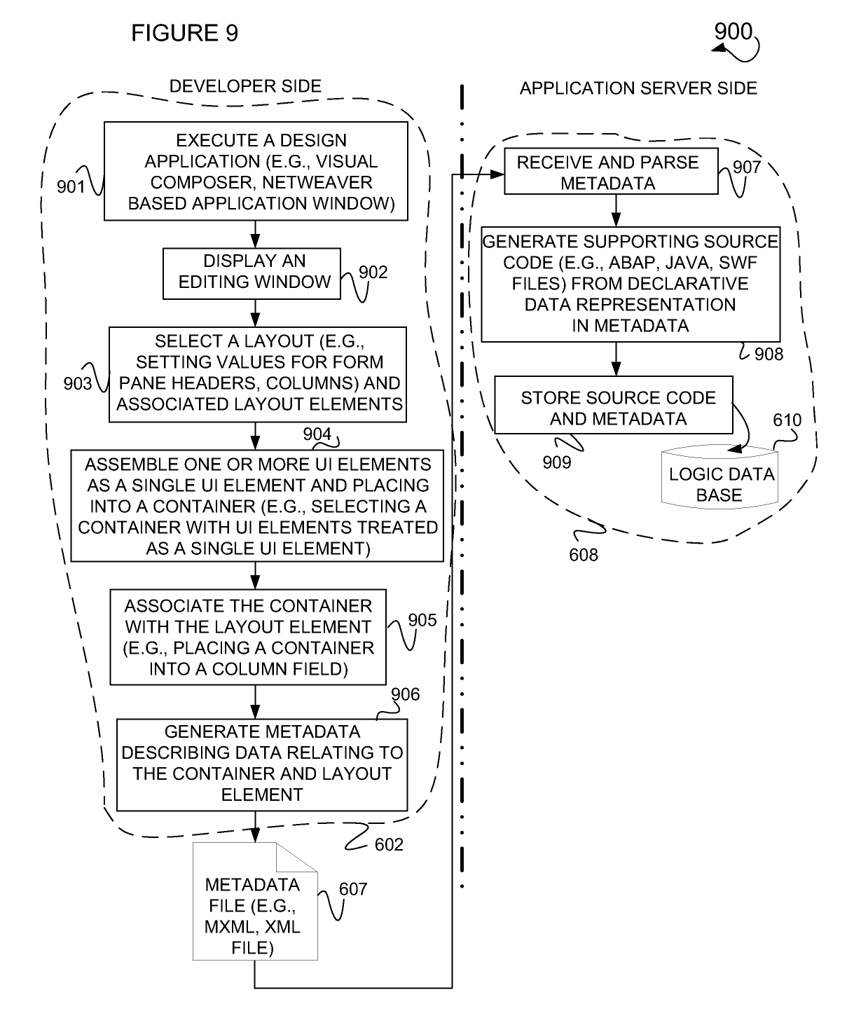

FIG. 9 is a flowchart illustrating an example method 900 used to generate a melting group container and associate this melting group container with a layout. Illustrated is an operation 901 that facilitates the execution of a design application, such as for example, VISUAL COMPOSER™ by SAP AG, or some other NET WEAVER™ based application. Next, an operation 902 is executed that displays an editing window. Once this editing window is displayed, operation 903 is executed that allows a user to select the layout which may include, for example, various layout elements such as form pane headers, columns or containers. Operation 904 illustrates the assembling of one or more UI elements as a single UI element (e.g., a melting group), and the placing of this now single UI element into a container (e.g., a melting group container). In such instances where one or more UI elements are placed into a container, the UI elements are treated as a single element such that issues of separation, spacing and/or sizing are relative only to the available space within the container, and are not relative to separation, spacing and/or sizing issues in the rest of a layout. At operation 905 the container containing the one or more UI elements is associated with a layout element. For example, a melting group container may be placed into a layout element such as a column. Once this association occurs, at operation 906, metadata illustrating the relationship between the melting group container and the particular layout element is generated. This metadata, such as metadata 607, is then, in some cases, transmitted to an application server 608.

When the metadata is received by the application server 608, an operation 907 is executed that receives and parses the metadata based upon some type of predetermined schema. In some cases, a flat file and associated delimiter value are used to format data relating to the created GUI. This schema may be based upon, for example, an EBXML standard. Next, at operation 908, supporting source code is generated from a declarative data representation in the metadata. Put another way, operation 908 takes the parsed metadata 607 and the representation contained therein of the association between the melting group container and, for example, a layout element in the form of a column, and generates supporting source code in the form of display logic and/or business logic. Once the display logic and/or business logic is generated, at operation 909, the source code and metadata is stored in the logic database 610.

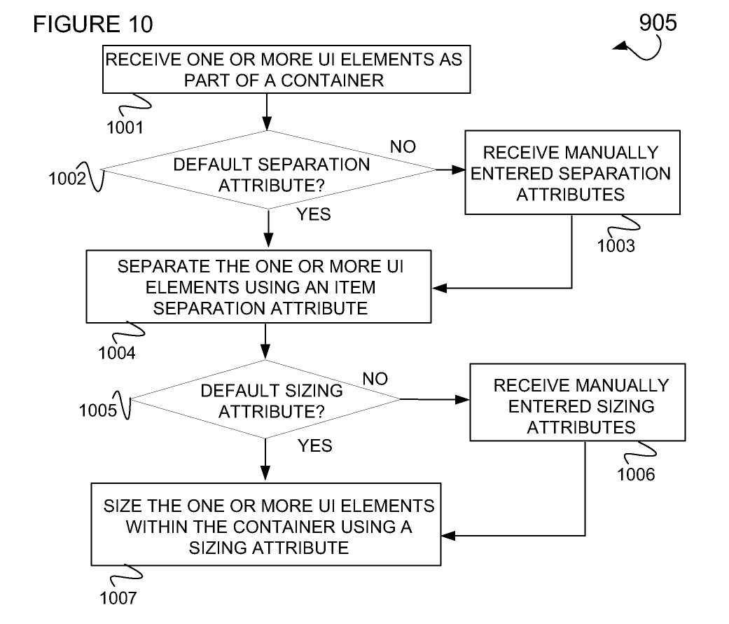

Example embodiments may include a method including assembling one or more UI elements as a single UI element and placing the single UI element into a container (see e.g., operation 904), associating the container with a layout element (see e.g., operation 905), and generating metadata (see e.g., operation 906), the metadata illustrating data relating to the container and the layout element. Additionally, this method may further include separating the one or more UI elements using an item separation attribute (see e.g., operation 1004 of FIG. 10), and sizing the one or more UI elements within the container using a sizing attribute (see e.g., operation 1007 of FIG. 10). Further, in some cases, the one or more UI elements include at least one of a container, table, graphic, item list box, explanatory text, textbox, button group, radio button group, or checkbox group. In addition, the metadata may be formatted using an XML. Moreover, in some cases, a separation attribute is utilized, wherein the separation value includes at least one of a pixel value, a character value, or a relative percent value. (See e.g., 301-304) In some cases, the method includes using a sizing attribute value, wherein this sizing attribute value includes at least one attribute value type including a pixel value, a character value, or a relative percent value (see e.g., 401-409).

FIG. 10 is a flowchart illustrating an example implementation of operation 905. At operation 1001, one or more UI elements that are part of a container are received. Once executed, a decisional operation 1002 is executed that determines whether or not certain default separation attributes have been set. In cases where decisional operation 1002 evaluates to “no”, at operation 1003, manually entered separation attributes are received. These manually entered separation attributes may be provided by, for example, a user. In cases where the decisional operation 1002 evaluates to “yes”, at operation 1004, the one or more UI elements are separated using an item separation attribute. This item separation attribute may be derived from the operation 1003 or may be derived from some type of default value. This default value may be, for example, the default spacing value 301 previously illustrated. Once the operation 1004 is executed, a further decisional operation 1005 is executed that determines whether a default sizing attribute has been set. In cases where default operation 1005 evaluates to “no”, at operation 1006, manually entered sizing attributes are received. In cases where decisional operation 1005 evaluates to “yes”, at operation 1007, one or more UI elements contained within the melting group container are sized using certain types of sizing attributes. Similarly, in cases where operation 1006 is executed, the operation 1007 is subsequently executed. As previously illustrated, sizing may be based upon such things as a relative percentage value.

### Example System for Rendering a Melting Group Container and a Layout Element

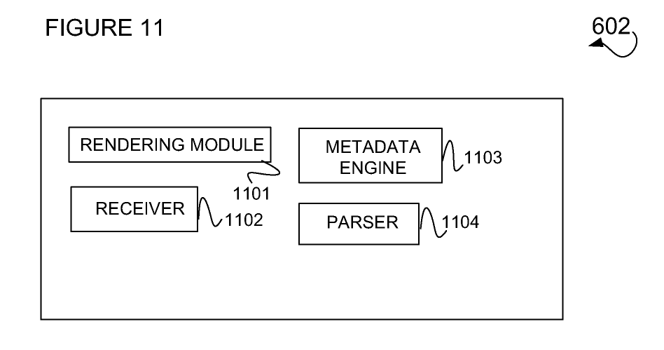

FIG. 11 is a block diagram of an example device 602. A rendering module 1101 is illustrated that renders an application GUI such as GUI 611. Also illustrated is a receiver 1102 that receives this application GUI 611. The receiver 1102 may be, for example, some type of network adaptor card or other type of device that facilitates an interface, or provides for an interface, between the one or more devices 602 and, for example, an application server 608. Also shown is a metadata engine 1103 that facilitates the taking of input as provided to the one or more UI elements associated with the melting group container such as 102 or 203, and then formats this data according to, for example, an EBXML standard. Additionally, a parser 1104 is shown that receives the application GUI 611 and parses it prior to providing it to the rendering module 1101 for display.

In some embodiments, a device 602 is illustrated as including a rendering module 1101 to render a melting group container in a display area of a user interface. This melting group container may have one or more UI elements assembled as a single element (e.g., a melting group). Further, a receiver 1102 is illustrated to receive input through the one or more UI elements. Next, a parser 1104 is illustrated to parse the input using a predefined grammar defined as part of a schema. Additionally, a metadata engine 1103 is illustrated to generate metadata illustrating the input, the metadata formatted according to the predefined grammar. Some example embodiments may also include these various modules (e.g., modules 1101-1104) residing on an application server such as application server 608. Further, in some embodiments, the device 602 includes one or more UI elements such as containers, tables, graphics, item list boxes, explanatory text, textboxes, button groups, radio button groups, and checkbox groups. Additionally, the previously illustrated grammar may include a grammar existing as part of an EBXML schema. Further, in some cases, a flat file may be used to format input data, wherein the flat file contains fields delimited with any number of delimiting characters.

### Example Method for Rendering a Melting Group Container and a Layout Element

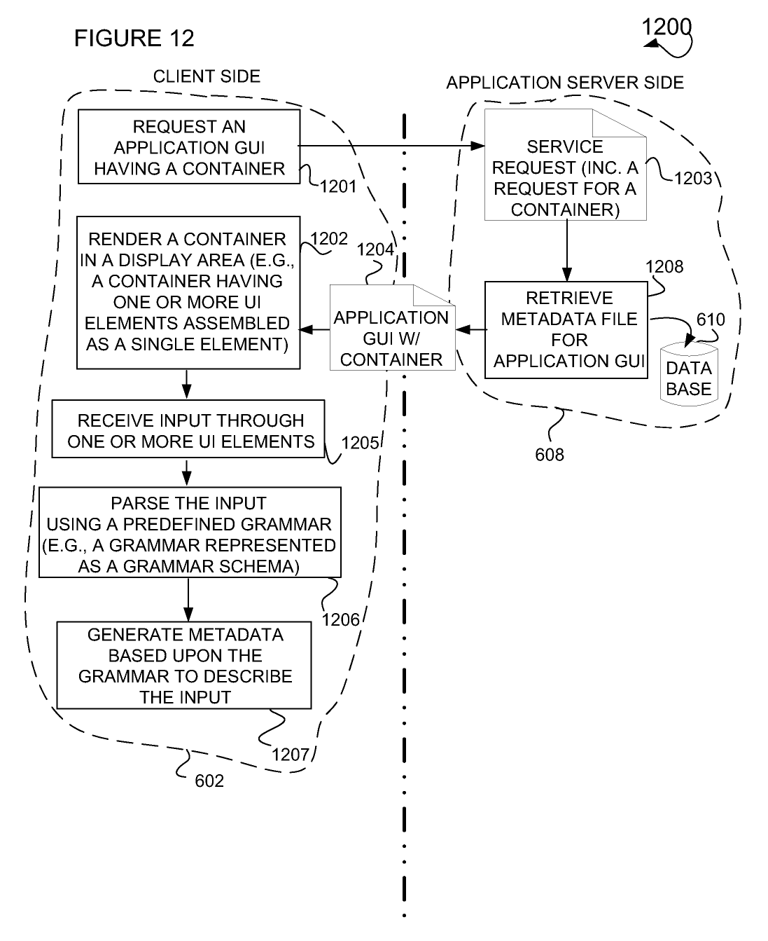

FIG. 12 is a flowchart illustrating an example method 1200 for rendering an application GUI such as GUI 611. At operation 1201, an application GUI is requested that has, for example, a melting group container. This request may take the form of a service request 1203 that is transmitted over some type of network, such as network 612, to, for example, an application server 608. Once received by the application server 608, an operation 1208 is executed that retrieves the metadata file corresponding to the service request 1203 from a logic database 610. Once retrieved from this logic database 610, an application GUI with a container, as reflected in 1204, is transmitted back across the network 612 to be processed by an operation 1202. Once received by the operation 1202, a melting group container is rendered within a particular display area, such as browser-based or stand-alone application 613. Next, at operation 1205, input is received through one or more UI elements. This input may be generated by using one or more input devices such a mouse, light pen, keyboard, or other suitable input device. This input is then parsed at operation 1206 using some type of predefined grammar or schema. Next, at operation 1207, metadata is generated based upon this grammar, wherein the metadata illustrates the input. This metadata may be formatted according to, for example, an EBXML standard.

Example embodiments may include a method comprising rendering a container in a display area of a user interface (see e.g., operation 1202), the container having one or more UI elements assembled as a single element, receiving input (see e.g., operation 1205) through the one or more UI elements, parsing the input using a predefined grammar (see e.g., operation 1206), the predefined grammar illustrating a grammar schema, and generating metadata (see e.g., operation 1207) illustrating the input, the metadata formatted according to the grammar schema. Further, the one or more UI elements may include at least one of a container, table, graphic, item list box, explanatory text, textbox, button group, radio button group, or checkbox group. Additionally, the grammar schema includes a schema, wherein the schema includes an EBXML schema. (See e.g., 1301-1304). Further, in some cases, a flat file may be used to format input data, wherein the flat file contains fields delimited with any number of delimiting characters.

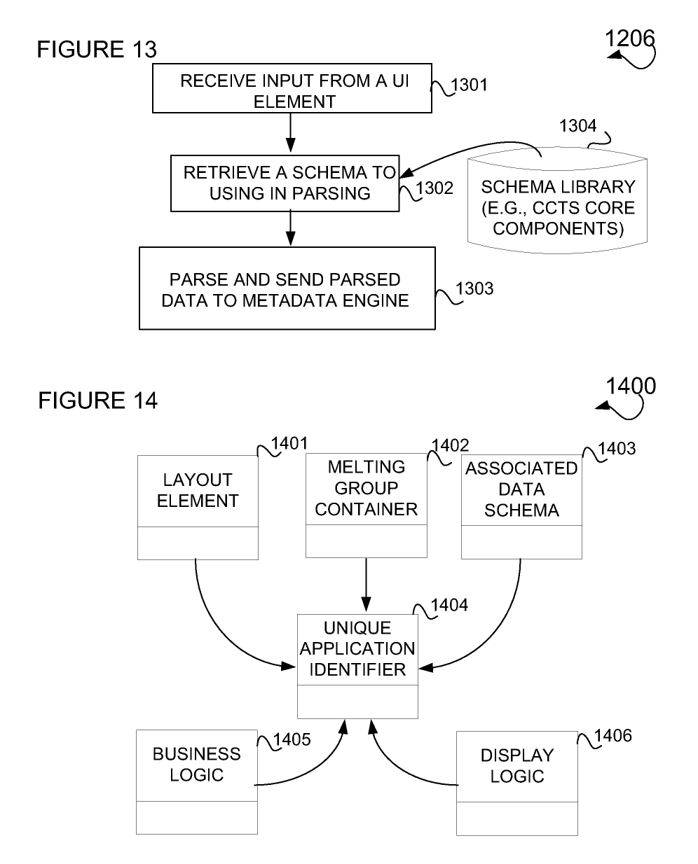

FIG. 13 is a flowchart illustrating an example method used to implement operation 1206. At operation 1301, input is received from the UI element. Next an operation 1302 is executed, where a schema is retrieved that is used to parse the input received from the UI element. This schema may be retrieved from, for example, a schema library (e.g., a database) 1304, and this schema may be, for example, a schema illustrating certain CCTS core components. The schema library 1304 may reside natively on, for example, one or more of the devices 602 or application server 608. Further, the schema library 1304 may be formatted based upon certain principles of OLAP and/or RDB. Once the schema is retrieved, at operation 1303 the parsed data is sent to a metadata engine that actually takes the input and formats it according to, for example, EBXML or some other suitable format as dictated by the schema retrieved from the schema library 1304.

### Example Database

Some embodiments may include the various databases (e.g., 610, 614, and 1304) being relational databases, or, in some cases, OLAP-based databases. In the case of relational databases, various tables of data are created and data is inserted into and/or selected from these tables using a Structured Query Language (SQL) or some other database-query language known in the art. In the case of OLAP databases, one or more multi-dimensional cubes or hyper cubes, containing multidimensional data from which data is selected from or inserted into using a Multidimensional Expression Language (MDX), may be implemented. In the case of a database using tables and SQL, a database application such as, for example, MYSQL™, SQLSERVER™, Oracle 8I™, 10G™, or some other suitable database application may be used to manage the data. In the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. These tables or cubes made up of tables, in the case of, for example, ROLAP, are organized into a Relational Data Base Schema (RDS) or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization, or optimization algorithm known in the art.

FIG. 14 is an example RDS 1400. Illustrated is a layout element table 1401 containing data relating to a layout element. This data may be, for example, the actual layout element itself contained as a Binary Large Object (BLOB), or may even be data formatted using some type of DTD or XSD, with the data stored as some type of XML compatible data type (e.g., an XML data type). Similarly, a melting group container table 1402 is illustrated that contains, for example, melting group containers as a BLOB or XML data type. Additionally, in some embodiments, an associated data schema table 1403 is implemented that contains, for example, a data schema that may be used to format the layout element and melting group container data in an XML format. This schema may be stored, for example, as an XML data type and may include a DTD, and/or a XSD. Additionally, a business logic table 1405 and display logic table 1406 are illustrated that contain the business logic and the display logic to implement an application GUI 611. The business logic and display logic may be stored as a BLOB, or even as a Character Large Object (CLOB) reflecting un-compiled source code. Further, a unique application identifier table 1404 is illustrated that acts, for example, as a table containing unique internal constraint values in the form of integer values and associated data types.

### Component Design

Some example embodiments may include the above-illustrated operations being written as one or more software components. Common too many of these components are the ability to generate, use, and manipulate the above-illustrated UI elements and layout elements and the data associated therewith. These components, and the functionality associated with each, may be used by client, server, or peer computer systems. These various components can be implemented into the system on an as-needed basis. These components may be written in an object-oriented computer language such that a component-oriented or object-oriented programming technique can be implemented using a Visual Component Library (VCL), Component Library for Cross Platform (CLX), Java Beans (JB), Enterprise Java Beans (EJB), Component Object Model (COM), or Distributed Component Object Model (DCOM) or other suitable technique. These components are linked to other components via various Application Programming Interfaces (APIs), or Business Application Programming Interfaces (BAPIs) and then compiled into one complete server and/or client application. The method for using components in the building of client and server applications is well known in the art. Further, these components may be linked together via various distributed programming protocols as distributed computing components.

### Distributed Computed Components and Protocols

Some example embodiments may include remote procedure calls being used to implement one or more of the above-illustrated components across a distributed programming environment. For example, a logic level may reside on a first computer system that is remotely located from a second computer system containing an interface level (e.g., a GUI). These first and second computer systems can be configured in a server-client, peer-to-peer, or some other configuration. These various levels can be written using the above-illustrated component design principles, and can be written in the same programming language or a different programming language. Various protocols may be implemented to enable these various levels, and components contained therein, to communicate regardless of the programming language used to write these components. For example, an operation written in C++ using the Common Object Request Broker Architecture (CORBA) or Simple Object Access Protocol (SOAP) can communicate with another remote module written in JAVA™. These protocols may include SOAP, CORBA, or some other suitable protocol. These protocols are well-known in the art.

### A Computer System

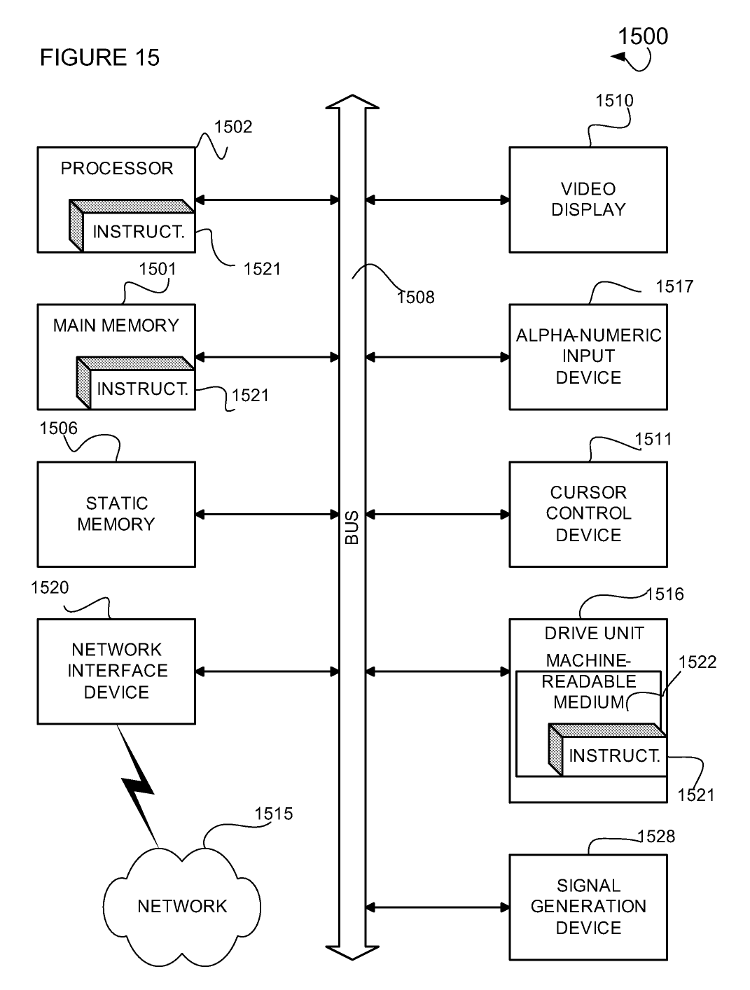

FIG. 15 shows a diagrammatic representation of a machine in the example form of a computer system 1500 that executes a set of instructions to perform any one or more of the methodologies discussed herein. One of the devices 602 may be configured as a computer system 1500. In alternative embodiments, the machine operates as a stand-alone device or may be connected (e.g., networked) to other machines. In a networked deployment, the machine may operate in the capacity of a server or a client machine in server-client network environment, or as a peer machine in a peer-to-peer (or distributed) network environment. The machine may be a PC, a tablet PC, a Set-Top Box (STB), a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 1500 includes a processor 1502 (e.g., a Central Processing Unit (CPU), a Graphics Processing Unit (GPU) or both), a main memory 1501, and a static memory 1506, which communicate with each other via a bus 1508. The computer system 1500 may further include a video display unit 1510 (e.g., a Liquid Crystal Display (LCD) or a Cathode Ray Tube (CRT)). The computer system 1500 also includes an alphanumeric input device 1517 (e.g., a keyboard), a UI cursor control device 1511 (e.g., a mouse), a disk drive unit 1516, a signal generation device 1528 (e.g., a speaker), and a network interface device (e.g., a transmitter) 1520.

The disk drive unit 1516 includes a machine-readable medium 1522 on which is stored one or more sets of instructions and data structures 1521 (e.g., software) embodying or used by any one or more of the methodologies or functions illustrated herein. The software may also reside, completely or at least partially, within the main memory 1501 and/or within the processor 1502 during execution thereof by the computer system 1500, the main memory 1501 and the processor 1502 also constituting machine-readable media.

The instructions 1521 may further be transmitted or received over a network 1515 via the network interface device 1520 using any one of a number of well-known transfer protocols (e.g., Hyper Text Transfer Protocol (HTTP), Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more methodologies illustrated herein. The term “machine-readable medium” shall accordingly be taken to include, but not be limited to, solid-state memories, optical and magnetic media, and carrier wave signals.

### Marketplace Applications

One exemplary advantage of an embodiment of the present system and method may include the use of certain schemas with one or more melting group containers that are associated with a particular layout element. In some cases, melting group containers allow for modular development techniques to be implemented as part of a development environment using a declarative programming regime. Specifically, rather than a software developer having to develop an application GUI one UI element at a time, and similarly having to write the display or business logic to support this UI element, a melting group container allows a software developer to automatically generate a melting group with predefined UI elements having predefined separation and sizing values. This saves the software developer development time, and makes the developer more efficient at their job. The UI elements that make up this melting group may have separation and sizing values that are unique to the melting group, relative to other UI elements and even melting group containers contained in the same layout. The melting group container may be associated with a layout element using a drag and drop method that is common to many editing windows that may appear in a development environment.

In addition to the melting group container being automatically generated, display logic and business logic associated with this melting group container may also be generated. Specifically, certain types of metadata illustrating the data (e.g., source code such as HTML based source code) used to generate the melting group container may be generated using, for example, an XML schema. The XML schema may include specific types of XML schemas reflecting industry standards (e.g., CCTS and EBXML). The automation of the UI element development process through the use of melting groups saves on software development time and makes for a more efficient development process.

The Abstract of the Disclosure is provided to comply with 37 C.F.R. §1.72(b), requiring an abstract that may allow the reader to quickly ascertain the nature of the technical disclosure. It is submitted with the understanding that it may not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
assembling one or more User Interface (UI) elements as a single UI element and placing the single UI element into a container, the container being a melting group container;
associating the container with a layout element; and
generating metadata, the metadata illustrating data relating to the container and the layout element.

2. The method of claim 1, further comprising:
separating the one or more UI elements using an item separation attribute; and
sizing the one or more UI elements within the container using a sizing attribute.

3. The method of claim 1, wherein the one or more UI elements include at least one of a container, table, graphic, item list box, explanatory text, textbox, button group, radio button group, or checkbox group.

4. The method of claim 1, wherein the metadata is formatted using an eXtensible Markup Language (XML).

5. The method of claim 2, wherein the item separation attribute is at least one of a pixel value, a character value, or a relative percent value.

6. The method of claim 2, wherein the sizing attribute is at least one of a pixel value, a character value, or a relative percent value.

7. A method comprising:
rendering a container in a display area of a user interface, the container having one or more User Interface (UI) elements assembled as a single element;
receiving input through the one or more UI elements;
parsing the input using a predefined grammar, the predefined grammar illustrating a grammar schema; and
generating metadata illustrating the input, the metadata formatted according to the grammar schema.

8. The method of claim 7, wherein the one or more UI elements include at least one of a container, table, graphic, item list box, explanatory text, textbox, button group, radio button group, or checkbox group.

9. The method of claim 7, wherein the grammar schema includes an eXtensible Markup Language (XML) schema.

10. The method of claim 9, wherein the XML schema includes an Electronic Business Extensible Markup Language (EBXML) schema.

11. A computer system comprising:
an assembly module to assemble one or more User Interface (UI) elements as a single UI element and to place the single UI element into a container, the container being a melting group container;
an association module to associate the container with a layout element; and
a metadata engine, the metadata engine to generate metadata illustrating data relating to the container and the layout element.

12. The computer system of claim 11, further comprising:
a separation module to separate the one or more UI elements using an item separation attribute; and
a sizing module to size the one or more UI elements within the container using a sizing attribute.

13. The computer system of claim 11, wherein the one or more UI elements include containers, tables, graphics, item list boxes, explanatory text, textboxes, button groups, radio button groups, and checkbox groups.

14. The computer system of claim 12, wherein the item separation attribute includes a pixel value, a character value, and a relative percent value.

15. The computer system of claim 12, wherein the sizing attribute includes a pixel value, a character value, and a relative percent value.

16. A computer system comprising:
a rendering module to render a container in a display area of a user interface, the container having one or more User Interface (UI) elements assembled as a single element;
a receiver to receive input through the one or more UI elements;
a parser to parse the input using a predefined grammar, the predefined grammar illustrating a grammar schema; and
a metadata engine to generate metadata illustrating the input, the metadata formatted according to the grammar schema.

17. The computer system of claim 16, wherein the one or more UI elements include containers, tables, graphics, item list boxes, explanatory text, textboxes, button groups, radio button groups, and checkbox groups.

18. The computer system of claim 16, wherein the grammar schema includes one or more Extensible Markup Language (XML) schemas.

19. The computer system of claim 18, wherein the one or more XML schemas include an Electronic Business Extensible Markup Language (EBXML) schema.

20. An apparatus comprising:
means for assembling one or more User Interface (UI) elements as a single UI element into a container, the container being a melting group container;
means for associating the container with a layout element; and
means for generating metadata, the metadata illustrating data relating to the container and the layout element.

21. A computer-readable medium embodying instructions, the instructions including:
a first instruction set to assemble one or more User Interface (UI) elements as a single UI element into a container, the container being a melting group container;
a second instruction set to associate the container with a layout element; and
a third instruction set to generate metadata, the metadata illustrating data relating to the container and the layout element.
